(19) United States
(12) Patent Application Publication
(10) Pub. No.: US 2025/0156617 A1
(43) Pub. Date: May 15, 2025

(54) SIMULATING DATA TRANSFERS FOR HIGH-LEVEL SYNTHESIS DESIGNS

(71) Applicant: Xilinx, Inc., San Jose, CA (US)

(72) Inventors: Lin-Ya Yu, San Jose, CA (US); Alexandre Isoard, San Jose, CA (US); Hem C. Neema, San Jose, CA (US); Luciano Lavagno, San Jose, CA (US); Chen Qianqiao, Beijing (CN); Xu Yang, Beijing (CN)

(73) Assignee: Xilinx, Inc., San Jose, CA (US)

(21) Appl. No.: 18/509,189

(22) Filed: Nov. 14, 2023

(51) Int. Cl. G06F 30/3312; G06F 119/12

(52) U.S. Cl. CPC G06F 30/3312; G06F 2119/12

(57) ABSTRACT

Computer-based co-simulation includes simulating a circuit design and a co-simulation model configured to model circuitry that operates in coordination with a hardware implementation of the circuit design. In response to a request for a data transfer received by the co-simulation model from the circuit design, a ready signal is provided from the co-simulation model to the circuit design after a first predetermined number of simulation clock cycles corresponding to an initiation interval of the circuitry modeled by the co-simulation model. In response to receiving state information for the data transfer, a response from the co-simulation model is provided to the circuit design after a second predetermined number of simulation clock cycles corresponding to a response time of the circuitry modeled by the co-simulation model.

### TECHNICAL FIELD

This disclosure relates to high-level synthesis of designs for integrated circuits (ICs) and to the simulation of such designs.

### BACKGROUND

High-Level Synthesis (HLS) refers to a technology that converts an untimed design specified in a high-level programming language (HLL) into a fully timed implementation (e.g., a circuit design) specified in a hardware description language (HDL). An example of an HDL is a register transfer level description or “RTL” description. The HDL description describes a synchronous digital circuit in terms of the flow of digital signals between hardware registers and operations performed on those signals. Once specified in HDL, the circuit design may be processed through a design flow, where the design flow may perform operations such as synthesis, placement, and routing. The processed circuit design may be implemented within an integrated circuit.

HLS design environments provide users with a simulation capability referred to as co-simulation. Co-simulation allows users to verify that the RTL generated from the HLL design has the same functionality as the HLL design. From the simulation, the performance and resource usage of the RTL may be observed. The user may revise and/or optimize the HLL design based on the results from the simulation.

### SUMMARY

In one or more example implementations, a computer-based method includes simulating a circuit design and a co-simulation model configured to model circuitry that operates in coordination with a hardware implementation of the circuit design. The circuit design and the co-simulation model may communicate during the simulation. The simulating includes, in response to a request for a data transfer received by the co-simulation model from the circuit design, providing, from the co-simulation model, a ready signal to the circuit design after a first predetermined number of simulation clock cycles corresponding to an initiation interval of the circuitry modeled by the co-simulation model. The simulating includes, in response to receiving state information for the data transfer, providing a response from the co-simulation model to the circuit design after a second predetermined number of simulation clock cycles corresponding to a response time of the circuitry modeled by the co-simulation model.

The foregoing and other implementations can each optionally include one or more of the following features, alone or in combination. Some example implementations include all the following features in combination.

In some aspects, the second predetermined number of simulation clock cycles is measured from receipt of the state information by the co-simulation model.

In some aspects, the circuitry modeled by the co-simulation model includes a memory controller and a memory coupled to the memory controller.

In some aspects, wherein the co-simulation model includes a sequencer and a plurality of drivers forming a communication bus interface of a communication bus between the co-simulation model and the circuit design.

In some aspects, one or more of the plurality of drivers are configured to count the first predetermined number of simulation clock cycles.

In some aspects, the sequencer is configured to count the second predetermined number of simulation clock cycles.

In some aspects, the data transfer is a read operation, the request includes assertion of a valid signal of a read address-control channel, and the response includes data read from an array of the co-simulation model. The data transfer may be a burst read operation.

In some aspects, the data transfer is a write operation and the request includes assertion of a valid signal of a write address-control channel and assertion of a valid signal of a write data channel. The data transfer may be a burst write operation.

In some aspects, the response is a valid signal asserted on a write response channel.

In one or more example implementations, a system includes one or more hardware processors configured (e.g., programmed) to execute operations as described within this disclosure.

In one or more example implementations, a computer program product includes one or more computer readable storage mediums having program instructions embodied therewith. The program instructions are executable by computer hardware, e.g., one or more hardware processors, to cause the computer hardware to initiate and/or execute operations as described within this disclosure.

This Summary section is provided merely to introduce certain concepts and not to identify any key or essential features of the claimed subject matter. Other features of the inventive arrangements will be apparent from the accompanying drawings and from the following detailed description.

### BRIEF DESCRIPTION OF THE DRAWINGS

The inventive arrangements are illustrated by way of example in the accompanying drawings. The drawings, however, should not be construed to be limiting of the inventive arrangements to only the particular implementations shown. Various aspects and advantages will become apparent upon review of the following detailed description and upon reference to the drawings.

FIG. 1 illustrates certain operative features of an example system in accordance with the inventive arrangements described within this disclosure.

FIG. 2 illustrates an example implementation of the co-simulation model of FIG. 1.

FIG. 3 is a signal flow diagram illustrating certain operative features of a circuit design in communication with a co-simulation model.

FIG. 4 is a method illustrating certain operative features of a co-simulation model interacting with a circuit design within a testbench.

FIG. 5 illustrates an example implementation of a data processing system.

### DETAILED DESCRIPTION

While the disclosure concludes with claims defining novel features, it is believed that the various features described within this disclosure will be better understood from a consideration of the description in conjunction with the drawings. The process(es), machine(s), manufacture(s) and any variations thereof described herein are provided for purposes of illustration. Specific structural and functional details described within this disclosure are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

This disclosure relates to high-level synthesis of designs for integrated circuits (ICs) and the simulation of such designs. HLS design environments provide simulation capabilities that allow a designer to check the functionality of a design being created in a high-level programming language (HLL). The simulation capabilities may fall into several different categories including functional simulation, co-simulation, and register transfer-level (RTL) simulation. Functional simulation refers to compiling the design, expressed in an HLL, into executable program code (e.g., object code) that may be executed by a processor. RTL simulation refers to converting the design into an RTL description and simulating the RTL description. Co-simulation refers to a simulation environment that includes both RTL components and executable components interacting with one another. The term “co-simulation” refers to the ability of the computing environment to execute or run both executable program code (e.g., object code model(s) generated from the HLL design) and RTL.

Often, a design must interact with one or more other circuits and/or systems. As an illustrative and non-limiting example, the design may be for a kernel that is required to access a memory system that includes a memory and a memory controller. The memory may be located off-chip relative to the kernel. In the case of functional simulation, an executable model of the memory system may be generated and executed rapidly but does not accurately reflect the real-world timing implications of the design interacting with the physical memory system. An RTL model of the memory system provides a more accurate timing assessment, but at the cost of consuming a significant amount of computing resources and time to simulate. For example, RTL simulation may take many hours rather than minutes as is the case with functional simulation.

Co-simulation, where the design is implemented in RTL and other systems with which the design interacts are implemented as executable models, like functional simulation, is also unable to provide an accurate assessment of the real-world timing implications of the design interacting with the physical memory system. That is, while the RTL portion may operate with accurate timing, operations performed by the executable models do not and appear to occur instantaneously. Such is the case as the executable models, when used to represent the memory system, presume a zero cost in terms of access time. Thus, when the design is implemented in actual hardware, the design's interactions with the real-world system, memory or otherwise, underperform the results from the HLS simulation.

This also means that executable models may not accurately reflect the timing implications of using different types of data transfers. Taking the memory system example, an executable model of the memory system that interacts with the design within a simulation may treat all data transfers, whether regular data transfers (e.g., individual reads and/or writes) or burst transfers (e.g., burst reads and/or burst writes) as occurring instantaneously. This treatment does not provide the designer with usable information as to the advantages or disadvantages of one type of data transfer over the other. This inability to accurately emulate different types of data transfers also may cause the hardware implementation of the design to underperform the simulated outcomes.

A burst transfer is technique that resolves the access data time bottleneck in a design. A burst transfer aggregates sequential (or consecutive) memory accesses and processes the memory accesses without performing all the steps for each memory access individually (e.g., as separate non-burst memory accesses) to improve performance when communicating with a memory system. A consecutive memory access refers to a plurality of sequentially executed memory accesses where each memory access accesses a next address in the memory such that the plurality of consecutive memory accesses access a continuous region of memory. A burst transfer may specify a starting address and a number of consecutive data items to access following the address. Put another way, a single burst transfer instruction may transfer X portions, or units (e.g., a predetermined number of bits such as a byte), of data whereas non-burst transfer operations would require X different instructions to transfer X portions, or units, of data.

In accordance with the inventive arrangements described within this disclosure, co-simulation models for circuitry are provided that, when used in the context of HLS simulation, provide more accurate timing information for transactions occurring between the co-simulation model and the design. The co-simulation models may be implemented using both HDL and executable program code to interact with the design and do so based on predetermined timing rules. The timing rules, as implemented by the co-simulation models, more accurately reflect the timing of the real-world operation of the hardware system being modeled. For example, the co-simulation models may more accurately reflect latency of the hardware system being modeled and/or more accurately reflect the timing of backpressure in the hardware system being modeled. The backpressure arises within the hardware system due to the initiation interval of the hardware system being modeled.

Accordingly, the techniques described herein relating to co-simulation allow data transfers to be simulated while providing more accurate information as to timing. Further, users are provided with a more accurate assessment and realistic view of the performance of a design using burst transfers and/or non-burst transfers without having to resort to using a full-fledged RTL model the memory system (e.g., the memory controller and memory) as well as the interconnects coupling the design to the memory system.

Further aspects of the inventive arrangements are described below with reference to the figures. For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

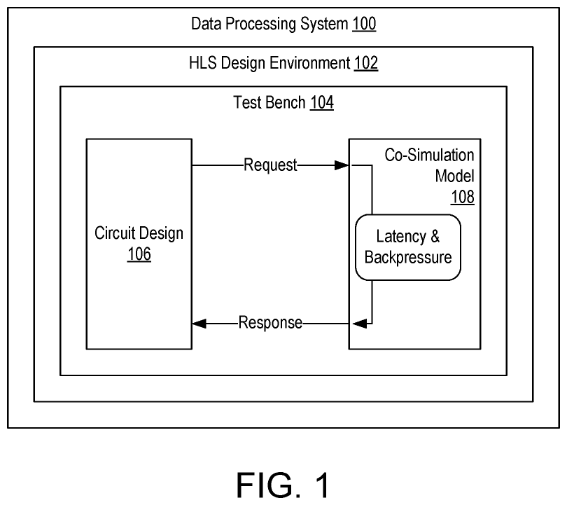

FIG. 1 illustrates certain operative features of an example system in accordance with the inventive arrangements described within this disclosure. As illustrated, a data processing system 100 is capable of executing an HLS Design Environment 102. HLS Design Environment 102 may be implemented as an executable framework, e.g., program code implementing one or more applications. Data processing system 100 executing HLS Design Environment 102 is an example of a computer-based Electronic Design Automation (EDA) system.

HLS Design Environment 102 allows a user to create a design specified in an HLL. Examples of HLLs can include, but are not limited to, C/C++, OpenCL, or other similar computer programming language source code. In the example, HLS Design Environment 102 is capable of generating a testbench 104. Within testbench 104, HLS Design Environment 102 includes a circuit design 106, also referred to herein as a “Design Under Test” or “DUT,” and a co-simulation model 108. Circuit design 106 is coupled to co-simulation model 108 within testbench 104.

In the example, circuit design 106 is an HDL (e.g., a Register Transfer Level or “RTL”) implementation or version of the design originally specified in HLL. HLS Design Environment 102 is capable of translating the design in HLL into HDL. The HDL or RTL version of the design specified in HLL is referred to herein as circuit design 106. HLS Design Environment 102 is further capable of simulating circuit design 106 through execution of testbench 104. During the simulation (e.g., execution of testbench 104), circuit design 106 interacts with co-simulation model 108. Though not shown, testbench 104 may include a driver that provides stimulus to circuit design 106 and a monitor that collects output generated by circuit design 106 for analysis and/or comparison with expected results to determine whether circuit design 106 is operating as expected (e.g., in accordance with a design specification and the same as the original design specified in HLL).

In the example, circuit design 106 may specify circuitry to be implemented in an IC. As an example, circuit design 106 may specify a kernel to be implemented in hardware, e.g., circuitry, of the IC. The hardware in which circuit design 106 is to be implemented may include hardened circuit components or programmable circuitry such as programmable logic. Co-simulation model 108 is a model of a system, e.g., circuitry, with which circuit design 106 interacts. Co-simulation model 108 may represent circuitry entirely within the same IC as circuit design 106, circuitry entirely external to the IC in which circuit design 106 is implemented, or a combination of both.

During the simulation, circuit design 106 is capable of issuing one or more requests to co-simulation model 108. Co-simulation model 108 is capable of responding to the received request and providing responses. Unlike other functional models, co-simulation model 108 is built with time management functions that mimic the actual latency and/or backpressure of the particular system being modeled. The behavior of co-simulation model 108 in terms of responding to circuit design 106 may be tuned to behave in an optimistic manner. For example, in terms of latency, co-simulation model 108 may be configured to respond to circuit design 106 after an amount of time determined to be the latency provided by the actual hardware being modeled. The latency may be an optimistic or minimal latency of the actual hardware. In other examples, the latency may be an average amount of latency of the actual hardware. In still other examples, the latency may be adjusted as a user preference for co-simulation model 108. In terms of backpressure, co-simulation model 108 may be configured to respond to circuit design 106 after an amount of time derived from, or equal to, the initiation interval of the actual hardware being modeled. The timing of co-simulation model 108 used for purposes of emulating the initiation interval and latency of the hardware being modeled may be specified and implemented in terms of clock cycles of testbench 104 referred to herein as “simulation clock cycles.”

In one or more example implementations, co-simulation model 108 mimics the behavior of a memory system. The memory system may include a memory controller, a memory, and the on-chip signal pathways (e.g., interconnects) that couple a physical realization of circuit design 106 with the physical memory system (e.g., the memory controller). The memory may be a Random Access Memory (RAM) with examples including, but not limited to, a Synchronous Dynamic RAM (SDRAM), a Double Data Rate RAM (DDR RAM), and the like. The memory may be any of a variety of different types of RAM. Co-simulation model 108 is capable of mimicking the round trip behavior of the memory system as a whole for purposes of evaluating the efficiency of operation of circuit design 106 and/or the efficiency with which circuit design 106 accesses the memory system as represented by co-simulation model 108.

For purposes of illustration, in the example of FIG. 1, testbench 104 models the case where the memory system modeled by co-simulation model 108 includes the interconnects and memory controller being disposed in the same IC as circuit design 106. The memory itself may be located off-chip, e.g., external to the IC that includes the implementation of circuit design 106 and the memory controller.

It should be appreciated, however, that testbench 104 and the various amounts of delay implemented may model one or more different real-world hardware architectures. In one or more example implementations, testbench 104 may model the case where the interconnects coupling circuit design 106 to the memory system, the memory controller, and the memory each is disposed in the same IC as circuit design 106. In one or more other examples, testbench 104 may model the case where the interconnects coupling circuit design 106 to the memory system and the memory controller both are disposed in the same IC as circuit design 106 while the memory is located off-chip. In one or more other examples, testbench 104 may model the case where the interconnects coupling circuit design 106 to the memory system may be disposed in the same IC as circuit design 106 while both the memory controller and the memory are located off-chip.

Without accounting for latency and/or backpressure, conventional approaches to co-simulation operate in a manner that presumes that data may be moved into memory, whether off-chip or on-chip, and back from the memory immediately (e.g., in zero simulation clock cycles). This presumption is unrealistic compared to real world scenarios where memory requires significant time to process each access request, fetch data, and/or store data. Without accounting for latency and/or backpressure of the memory system, users are not provided with meaningful data as to the impact of using burst transfers or non-burst transfers for their designs.

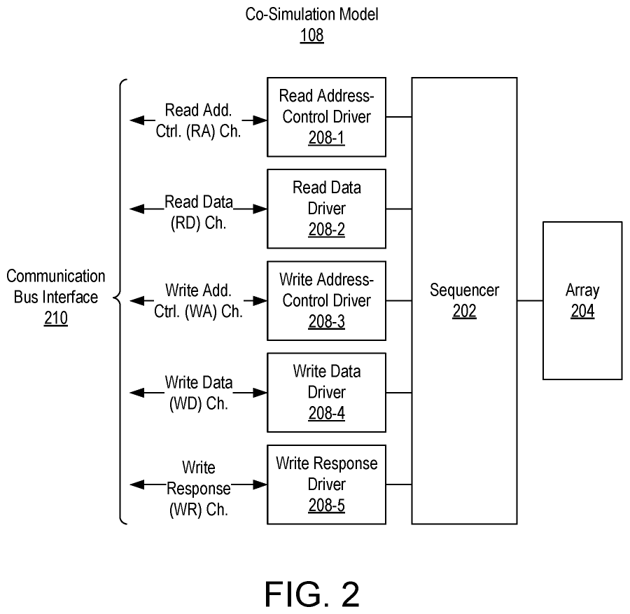

FIG. 2 illustrates an example implementation of co-simulation model 108. In the example of FIG. 2, co-simulation model 108 includes a sequencer 202, an array 204, and a plurality of drivers 208. In the example, co-simulation model 108, through drivers 208, implements a memory-mapped interface through which circuit design 106 may interact. Drivers 208 are the components of co-simulation model 108 that interface with the different channels of the memory-mapped interface.

For example, co-simulation model 108 includes a read address-control driver 208-1 that communicates over a read address-control channel (RA channel); a read data driver 208-2 that communicates over a read data channel (RD channel); a write address control driver that communicates over a write address control channel (WA channel); a write data driver that communicates over a write data channel (WD channel); and a write response driver that communicates over a write response channel (WR channel).

In the example, the RA channel carries address information for read operations and control information for read operations. The RD channel carries the data that is read from array 204 in response to a read request. The WA channel carries address information for write operations and control information for write operations. The WD channel carries the data to be written to memory for a write operation. The WR channel carries acknowledgements of successful write operations. In the example of FIG. 2, the drivers 208, taken collectively, form a communication bus interface 210 for the communication bus including the RA channel, RD channel, WA channel, WD channel, and WR channel coupling circuit design 106 and co-simulation model 108.

In the example, each driver 208 is capable of receiving RTL signals on its respective channel of the memory-mapped interface and/or generating RTL signal responses on the respective channel. In this regard, each driver 208 provides an RTL interface between circuit design 106 and other portions of co-simulation model 108 such as sequencer 202 and/or array 204. Drivers 208 effectively operate as an interface to a memory converting RTL signals to HLL transactions and HLL transactions to RTL signals.

Each of the drivers 208 is capable of communicating with sequencer 202 to provide information to sequencer 202 and/or respond to triggers from sequencer 202. Drivers 208, for example, simulate the handshaking input/output (I/O) of a memory with circuit design 106. Sequencer 202 is configured to operate as the memory itself. That is, in general, sequencer 202 simulates the process of obtaining addresses and handling associated data.

Delays implemented by co-simulation model 108 may be handled within or by drivers 208 and/or sequencer 202. In one or more examples, the delays implemented by drivers 208 emulate the initiation interval of the memory system. The delays implemented by sequencer 202 emulate the latency of the memory system. In one or more examples, where System Verilog is used, the timing operations, e.g., delays, implemented by drivers 208 and/or sequencer 202, may be implemented using System Verilog and/or System Verilog functions which facilitates the timing of operations in accordance with simulation time (e.g., simulation clock cycles). This implementation, using HDL to track and/or monitor time in terms of simulation clock cycles, allows the inventive arrangements described herein to be used within any simulator that supports the HDL (e.g., System Verilog or another HDL implementing similar co-simulation functionality) used to implement circuit design 106 and/or co-simulation model 108.

While drivers 208 implement an RTL interface to circuit design 106 and may do so using an HDL implementation, other portions of drivers 208 that interact with sequencer 202 may be implemented in an HLL and compiled into object code that may be called by the respective HDL portions of the respective drivers 208. Sequencer 202 is capable of communicating with the respective drivers 208, receiving address information for read operations or write operations, and performing reads and/or writes on array 204. Sequencer 202, for example, may include read and write functions that perform reads and/or writes of array 204 by converting address information that is received from read address-control driver 208-1 and/or write address-control driver 208-3 into an index into array 204. Sequencer 202 then performs the read or write with respect to the index (e.g., writing Y bytes of data starting at the index or reading Y bytes of data starting at the index).

Portions of sequencer 202 may be specified using an HLL, compiled into object code, and executed during the simulation. Array 204 may be specified in HLL and compiled into object code that is executed. As noted, timing functions that implement the latency delays may be implemented in HDL that may call and/or otherwise interact with the HLL functions. By implementing portions of sequencer 202 and array 204 in object code, the speed of execution of co-simulation model 108 may be increased. In the examples described herein, co-simulation model 108 is configured to emulate the initiation interval of the memory system for a burst and/or non-burst transfer and/or the latency incurred for a burst and/or non-burst transfer. The initiation interval and the latency for burst transfers may be the same as the initiation interval and the latency, respectively, for non-burst transfers.

In the example of FIG. 2, sequencer 202 is configured to coordinate operation of each of the channels illustrated by way of communicating with drivers 208. In one or more example implementations, the memory-mapped interface illustrated in FIG. 2 may be an Advanced Microcontroller Bus Architecture (AMBA) extensible Interface (AXI) compatible interface. AXI defines an embedded microcontroller bus interface for use in establishing on-chip connections between compliant circuit blocks and/or systems. It should be appreciated that AXI is provided for purposes of illustration and is not intended as a limitation of the examples described within this disclosure. Other communication buses, interconnects, and/or communication protocols may be used in lieu of the example provided.

For each operation, sequencer 202 is capable of triggering transfers and/or aspects of transfers in different ones of drivers 208 to perform the entire operation including receiving address information, passing data, and/or sending a response. The behavior of sequencer 202 is implemented based on the operation type (e.g., read or write) of the particular communication protocol or standard used. In the example, for every channel (e.g., for every memory-mapped AXI channel in this example), there is an attached driver 208 that is capable of driving the handshake signaling for the channels of co-simulation model 108.

In one or more example implementations, sequencer 202 may be implemented as a Universal Verification Methodology (UVM) compatible sequencer. UVM refers to a standardized methodology for verifying digital designs and systems-on-chip (SoCs) in the semiconductor industry. In general, UVM is built on top of the System Verilog language and provides a framework for creating modular, reusable testbench components that can be integrated into the design verification process. UVM also includes a set of guidelines and best practices for developing testbenches, as well as a methodology for running simulations and analyzing results.

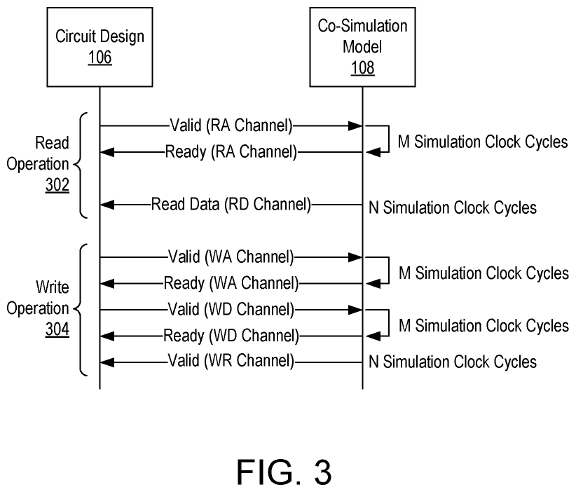

FIG. 3 is a signal flow diagram illustrating certain operative features of circuit design 106 in communication with co-simulation model 108. In the example, in no particular order, signaling for a read operation 302 and signaling for a write operation 304 are shown. Read operation 302 may be a burst read operation or a non-burst read operation. Similarly, write operation 304 may be a non-burst write operation or a burst write operation. For both the read operation 302 and the write operation 304, co-simulation model 108 is capable of accurately modeling the behavior, e.g., timing, of the memory system in performing a data transfer, whether the data transfer is a burst or non-burst transfer.

Within the example of FIG. 3, the value M specifies the number of simulation clock cycles in testbench 104 used to emulate back pressure. Back pressure is a measure of how often the memory system is capable of receiving new input, e.g., a new request for a data transfer. In this example, the memory controller of the memory architecture modeled by co-simulation model 108 is capable of receiving a new request (e.g., a request for a read operation or a write operation) every M simulation clock cycles. For purposes of illustration, M may be set equal to 4 in the examples described herein. That is, the memory system was able to handle requests with an initiation interval of 4 simulation clock cycles.

Within the example of FIG. 3, the value N specifies the number of simulation clock cycles in testbench 104 that represents round-trip latency. Round-trip latency, or sometime referred to herein as latency, may be determined based on the average time required to receive data after initiating a read operation or to receive an acknowledgement in response to initiating a write operation. In this example, the memory controller of the memory architecture modeled by co-simulation model 108 is capable of outputting a response, e.g., data or an acknowledgement, after N simulation clock cycles. For purposes of illustration, N may be set equal to 30 in the examples described herein. As noted, the value of N represents the delay of the memory architecture for sending back the first data which may include any memory (e.g., DDR) preparation time, time for signals to traverse the interconnect between circuit design 106 and the memory controller, and/or the like.

In the example, the value of M for read operations is independent of the value of M for write operations. That is, subsequent to a first read operation, a second read operation may not be received until M simulation clock cycles after the first read operation, while a write operation may be received in less than M simulation clock cycles after the first read operation. Similarly, subsequent to a first write operation, a second write operation may not be received until M simulation clock cycles after the first write operation, while a read operation may be received in less than M simulation clock cycles after the first write operation. The value of N for read operations is similarly independent of the value of M for write operations.

Referring to read operation 302, the RA channel and the RD channel are used. In the example, circuit design 106 is capable of initiating read operation 302 by submitting a read request. As shown, circuit design 106 is capable of sending a read request by asserting a valid signal to co-simulation model 108 on the RA channel. Read address-control driver 208-1 receives the valid signal (e.g., the valid signal goes high) and, in response, counts M simulation clock cycles. In response to counting the M simulation clock cycles (e.g., the expiration of M simulation clock cycles after receiving the read request), read address-control driver 208-1 responds over the RA channel with a ready signal by bringing the ready signal high. For example, read address-control driver 208-1 brings the ready signal high in response to counting M simulation clock cycles after receiving the valid signal (e.g., the rising edge of the valid signal) on the RA channel. While both the valid signal and the ready signal are high, circuit design 106 continues read operation 302 by providing state information on the RA channel. The state information for read operation 302 includes an address and number of bytes to be read. The M simulation clock cycle delay prevents co-simulation model 108 from receiving read requests with a shorter initiation interval than the actual hardware being modeled.

In the example, read address-control driver 208-1 is capable of responding after M simulation clock cycles without interacting with sequencer 202. In response to receiving the address and number of bytes to be read, read address-control driver 208-1 is capable of providing the state information to sequencer 202. The state information provided from read address-control driver 208-1 serves as a notification to sequencer 202 of the read request.

Sequencer 202, in response to the state information, saves the state information, e.g., the address and number of bytes to be read, in a buffer. The buffer may be implemented as a queue. Sequencer 202 may store the state information in the buffer for N simulation clock cycles. In response to the state information for read operation 302 being stored in the buffer for N simulation clock cycles (e.g., in response to the expiration of N simulation clock cycles after receiving the state information in the buffer), sequencer 202 performs read operation 302. For example, sequencer 202 extracts the state information for read operation 302 from the buffer, translates the address into an index into array 204, reads the amount of requested data starting from the index in array 204 (e.g., a single unit of data (e.g., a byte) for a non-burst transfer and multiple units of data for a burst transfer), and writes the data to read data driver 208-2. Read data driver 208-2 provides the data for read operation 302 to circuit design 106 over the RD channel in response to receiving the data (e.g., without any further delay). In the example, it should be appreciated that operations such as storing state information, translating the address to an index, reading or writing to array 204, and communicating between a driver 208 and sequencer 202 may take place much faster (e.g., in object code time using native clock cycles of the computer system being used) as opposed to the much slower simulation time. In this respect, such operations whether for read operation 302 or write operation 304 do not consume simulation clock cycles.

In one or more example implementations, the buffer of sequencer 202 that is used to store the state information for read operations may include sufficient space for storing state information for up to N different read operations. The buffer, or queue, may include N different slots, where each slot or portion of the buffer, stores the state information for one read operation, to ensure that sufficient space is available to hold state information for read requests while implementing the required latency of N simulation clock cycles. The N simulation clock cycles reflects the round-trip latency of the memory system. In one or more other embodiments, since read requests may only be received every M simulation clock cycles, the buffer may include fewer slots, such as N/M rounded up to the nearest integer value number of slots.

Referring to write operation 304, the WA channel, the WD channel, and the WR channel are used. In the example, circuit design 106 is capable of initiating write operation 304 by submitting a write request. As shown, circuit design 106 is capable of submitting a write request by asserting a valid signal to co-simulation model 108 on the WA channel. Write address-control driver 208-3 receives the valid signal (e.g., the valid signal goes high) and, in response, counts M simulation clock cycles. In response to counting the M simulation clock cycles (e.g., the expiration of M simulation clock cycles), write address-control driver 208-3 responds over the WA channel with a ready signal (bringing the ready signal high). For example, write address-control driver 208-3 brings the ready signal high in response to counting M simulation clock cycles after receiving the valid signal (e.g., the rising edge of the valid signal) on the WA channel. While both the valid signal and the ready signal are high, circuit design 106 sends state information for write operation 304 by providing an address over the RA channel. The M simulation clock cycle delay prevents co-simulation model 108 from receiving write requests with a smaller initiation interval than the actual hardware being modeled. In the example, write address-control driver 208-3 is capable of responding after M simulation clock cycles without interacting with sequencer 202.

The write request further includes circuit design 106 asserting a valid signal to co-simulation model 108 on the WD channel. Write data driver 208-4 receives the valid signal (e.g., the valid signal goes high) and, in response, counts M simulation clock cycles. In response to counting the M simulation clock cycles (e.g., the expiration of M simulation clock cycles), write data driver 208-4 responds over the WD channel with a ready signal (bringing the ready signal high). For example, write data driver 208-4 brings the ready signal high in response to counting M simulation clock cycles after receiving the valid signal (e.g., the rising edge of the valid signal) on the WD channel cycles (e.g., in response to the expiration of M simulation clock cycles). While both the valid signal and the ready signal are high, circuit design 106 provides state information including the data to be written over the WD channel. The data to be written may be provided over one or more simulation clock cycles depending on whether the data transfer is a burst or non-burst transfer. The M simulation clock cycle delay prevents co-simulation model 108 from receiving more write requests with a smaller initiation interval than the actual hardware being modeled. In the example, write data driver 208-4 is capable of responding after M simulation clock cycles without interacting with sequencer 202.

In one or more examples, write address-control driver 208-3 and write data driver 208-4 provide the state information to sequencer 202. Receipt of the state information may serve as a notification to sequence 202 of the receipt of a write request. In some examples, the state information for write operation 304, as received by write address-control driver 208-3 may include a value with the address, where the value specifies a number of bytes of data to be written. In other examples, the state information for write operation 304 does not provide a number explicitly and instead infers the number of bytes to be written based on the amount of data received by write data driver 208-4 as the state information.

In the example, the valid signal on the WA channel and the valid signal on the WD channel may be received at the same time, e.g., on the same simulation clock cycle. Similarly, the valid signal provided on the WA channel and the valid signal provided on the WD channel may be sent at the same time, e.g., on the same simulation clock cycle.

Sequencer 202, in response to receiving the state information for write operation 304, in reference to the address and data to be written, saves the state information in a buffer. The buffer may be implemented as a queue. Sequencer 202 may store the state information in the buffer for N simulation clock cycles. In response to the state information for write operation 304 being stored in the buffer for N simulation clock cycles (e.g., in response to the expiration of N simulation clock cycles after receiving the state information in the buffer), sequencer 202 performs write operation 304.

For example, sequencer 202 performs the write operation 304 by extracting the state information from the buffer, translating the address into an index into array 204, writing the data that was received at sequential location(s) starting at the index (e.g., writing a single unit of data for a non-burst transfer or multiple units of data for a burst transfer) in array 204, and providing an indication to write response driver 208-5 indicating that the write is complete.

The buffer implemented by sequencer 202 for write operations may operate similar to the buffer implemented for read operations in terms of number of slots (e.g., N different slots or N/M rounded up to the next nearest integer slots). It should be appreciated that the size of the individual slots may be larger to accommodate the data to be written.

Write response driver 208-5, in response to the indication from sequencer 202, sends the response (e.g., a valid signal) on the WR channel to circuit design 106. For example, write response driver 208-5 brings the ready signal high on the WR channel. The N simulation clock cycles reflects the round-trip latency of the memory system.

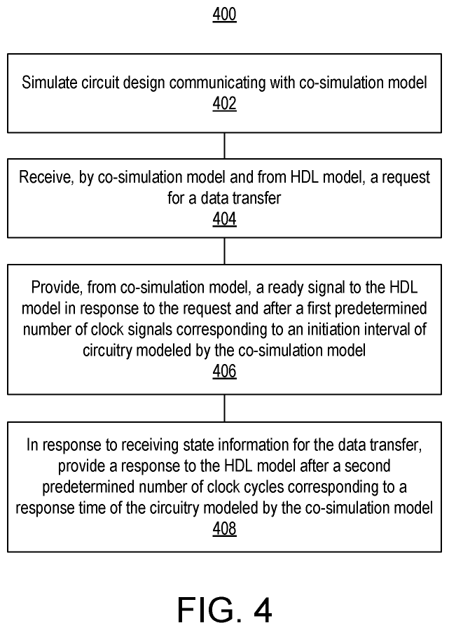

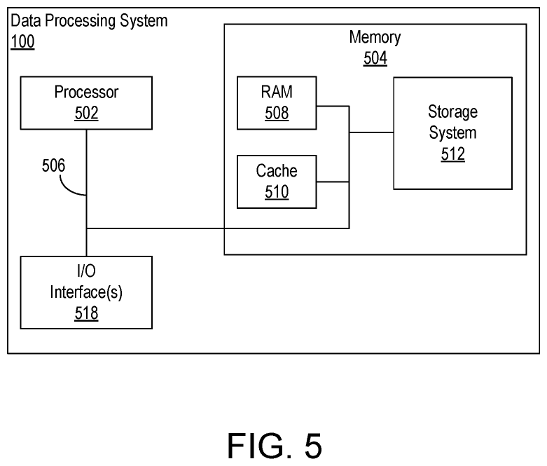

FIG. 4 is a method 400 illustrating certain operative features of the co-simulation model 108 interacting with circuit design 106 within testbench 104. Method 400 may be performed using computer hardware (referred to as “the system” below). An example of computer hardware capable of performing the operations described within this disclosure is described herein in connection with FIG. 5.

In block 402, the system simulates circuit design 106 communicating with co-simulation model 108. Co-simulation model 108 is configured to model circuitry that operates in coordination with a hardware implementation of circuit design 106. Taken collectively, the hardware implementation of circuit design 106 and the circuitry modeled by co-simulation model 108 is an example of an electronic system that may be simulated using testbench 104 (e.g., through execution of testbench 104). As discussed, testbench 104 includes circuit design 106, which is an HDL model of the design originally specified in an HLL, and co-simulation model 108.

In block 404, as part of the simulating of block 402, co-simulation model 108 receives a request for a data transfer from circuit design 106.

In block 406, as part of the simulating of block 402, in response to the request for a data transfer received by co-simulation model 108 from circuit design 106, co-simulation model 108 is capable of providing or asserting a ready signal to circuit design 106 after a first predetermined number of simulation clock cycles M corresponding to an initiation interval of the circuitry modeled by the co-simulation model.

In block 408, as part of the simulating of block 402, in response to receiving state information for the data transfer, co-simulation model 108 provides a response to circuit design 106 after a second predetermined number of simulation clock cycles N that correspond to a response time (e.g., latency) of the circuitry modeled by the co-simulation model.

As discussed, the circuitry modeled by co-simulation model 108 can include a memory controller and a memory coupled to the memory controller. The circuitry modeled by co-simulation model 108 also may include interconnect circuitry that couples circuit design 106 with the memory controller.

In one or more examples, the second predetermined number of simulation clock cycles is measured from receipt of the state information by the co-simulation model. For example, the second predetermined number of simulation clock cycles may be measured from receipt of the state information by sequencer 202 from the involved drivers 208.

In one or more examples, co-simulation model 108 includes sequencer 202 and a plurality of drivers 208. The plurality of drivers implement a communication bus interface for the plurality of channels of a communication bus between co-simulation model 108 and circuit design 106. In one aspect, the plurality of drivers correspond to the plurality of channels on a one-to-one basis.

In one or more examples, one or more of the plurality of drivers are configured to count the first predetermined number of simulation clock cycles.

In one or more examples, the sequencer is configured to count the second predetermined number of simulation clock cycles.

In an example where the data transfer is a read operation, whether a burst or non-burst transfer, the request includes assertion of a valid signal of an RA channel, and the response include the read data (e.g., the data read from the memory as represented by array 204). The ready signal is provided on the RA channel.

In an example where the data transfer is a write operation, whether a burst or non-burst transfer, and the request includes assertion of a valid signal of a WA channel and assertion of a valid signal of a WD channel. The ready signal may include a first ready signal provided over the WA channel responsive to the valid signal received on the WA channel. The ready signal may include a second ready signal provided over the WD channel responsive to the valid signal received on the WD channel. The response can include a valid signal asserted on a WR channel.

FIG. 5 illustrates an example implementation of a data processing system 100. As defined herein, the term “data processing system” means one or more hardware systems configured to process data, each hardware system including at least one processor and memory, wherein the processor is programmed with computer-readable instructions that, upon execution, initiate operations. Data processing system 100 can include a processor 502, a memory 504, and a bus 506 that couples various system components including memory 504 to processor 502.

Processor 502 may be implemented as one or more processors. In an example, processor 502 is implemented as a central processing unit (CPU). Processor 502 may be implemented as one or more circuits, e.g., hardware, capable of carrying out instructions contained in program code. The circuit may be an integrated circuit or embedded in an integrated circuit. Processor 502 may be implemented using a complex instruction set computer architecture (CISC), a reduced instruction set computer architecture (RISC), a vector processing architecture, or other known architectures. Example processors include, but are not limited to, processors having an x86 type of architecture (IA-32, IA-64, etc.), Power Architecture, ARM processors, and the like.

Bus 506 represents one or more of any of a variety of communication bus structures. By way of example, and not limitation, bus 506 may be implemented as a Peripheral Component Interconnect Express (PCIe) bus. Data processing system 100 typically includes a variety of computer system readable media. Such media may include computer-readable volatile and non-volatile media and computer-readable removable and non-removable media.

Memory 504 can include computer-readable media in the form of volatile memory, such as random-access memory (RAM) 508 and/or cache memory 510. Data processing system 100 also can include other removable/non-removable, volatile/non-volatile computer storage media. By way of example, storage system 512 can be provided for reading from and writing to a non-removable, non-volatile magnetic and/or solid-state media (not shown and typically called a “hard drive”), which may be included in storage system 512. Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 506 by one or more data media interfaces. Memory 504 is an example of at least one computer program product.

Memory 504 is capable of storing computer-readable program instructions that are executable by processor 502. For example, the computer-readable program instructions can include an operating system, one or more application programs (e.g., HLS Design Environment 102 and/or testbench 104), other program code, and program data. Processor 502, in executing the computer-readable program instructions, is capable of performing the various operations described herein that are attributable to a computer. It should be appreciated that data items used, generated, and/or operated upon by data processing system 100 are functional data structures that impart functionality when employed by data processing system 100. As defined within this disclosure, the term “data structure” means a physical implementation of a data model's organization of data within a physical memory. As such, a data structure is formed of specific electrical or magnetic structural elements in a memory. A data structure imposes physical organization on the data stored in the memory as used by an application program executed using a processor.

Data processing system 100 may include one or more Input/Output (I/O) interfaces 518 communicatively linked to bus 506. I/O interface(s) 518 allow data processing system 100 to communicate with one or more external devices and/or communicate over one or more networks such as a local area network (LAN), a wide area network (WAN), and/or a public network (e.g., the Internet). Examples of I/O interfaces 518 may include, but are not limited to, network cards, modems, network adapters, hardware controllers, etc. Examples of external devices also may include devices that allow a user to interact with data processing system 100 (e.g., a display, a keyboard, and/or a pointing device) and/or other devices such as accelerator card.

Data processing system 100 is only one example implementation. Data processing system 100 can be practiced as a standalone device (e.g., as a user computing device or a server, as a bare metal server), in a cluster (e.g., two or more interconnected computers), or in a distributed cloud computing environment (e.g., as a cloud computing node) where tasks are performed by remote processing devices that are linked through a communications network. In a distributed cloud computing environment, program modules may be located in both local and remote computer system storage media including memory storage devices.

The example of FIG. 5 is not intended to suggest any limitation as to the scope of use or functionality of example implementations described herein. Data processing system 100 is an example of computer hardware that is capable of performing the various operations described within this disclosure. In this regard, data processing system 100 may include fewer components than shown or additional components not illustrated in FIG. 5 depending upon the particular type of device and/or system that is implemented. The particular operating system and/or application(s) included may vary according to device and/or system type as may the types of I/O devices included. Further, one or more of the illustrative components may be incorporated into, or otherwise form a portion of, another component. For example, a processor may include at least some memory.

In the example of FIG. 5, the computer readable program instructions may include program code that, upon execution, causes processor 502 to perform a design flow. A design flow can include computer-based operations such as synthesis, placement, routing, and/or configuration data generation. The design flow facilitates the physical realization of circuit design 106 within target hardware such as an IC. That is, circuit design 106 may be physically realized in an IC by virtue of performing the design flow. The IC may be any of a variety of ICs whether an Application Specific IC (ASIC), a System-on-Chip (SoC), a programmable IC (e.g., an IC including at least some programmable circuitry), or the like. Programmable logic is an example of programmable circuitry.

The terminology used herein is for the purpose of describing particular embodiments only and is not intended to be limiting. Notwithstanding, several definitions that apply throughout this document are expressly defined as follows.

As defined herein, the singular forms “a,” “an,” and “the” are intended to include the plural forms as well, unless the context clearly indicates otherwise.

As defined herein, the terms “at least one,” “one or more,” and “and/or,” are open-ended expressions that are both conjunctive and disjunctive in operation unless explicitly stated otherwise. For example, each of the expressions “at least one of A, B, and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

As defined herein, the term “automatically” means without human intervention.

As defined herein, the term “computer-readable storage medium” means a storage medium that contains or stores program instructions for use by or in connection with an instruction execution system, apparatus, or device. As defined herein, a “computer-readable storage medium” is not a transitory, propagating signal per se. The various forms of memory, as described herein, are examples of computer-readable storage media. A non-exhaustive list of examples of computer-readable storage media include an electronic storage device, a magnetic storage device, an optical storage device, an electromagnetic storage device, a semiconductor storage device, or any suitable combination of the foregoing. A non-exhaustive list of more specific examples of a computer-readable storage medium may include: a portable computer diskette, a hard disk, a RAM, a read-only memory (ROM), an erasable programmable read-only memory (EPROM or Flash memory), an electronically erasable programmable read-only memory (EEPROM), a static random-access memory (SRAM), a portable compact disc read-only memory (CD-ROM), a digital versatile disk (DVD), a memory stick, a floppy disk, or the like.

As defined herein, “execute” and “run” comprise a series of actions or events performed by the hardware processor in accordance with one or more machine-readable instructions or program code. “Running” and “executing,” as defined herein refer to the active performing of actions or events by the hardware processor. The terms run, running, execute, and executing are used synonymously herein.

As defined herein, the term “if” means “when” or “upon” or “in response to” or “responsive to,” depending upon the context. Thus, the phrase “if it is determined” or “if [a stated condition or event] is detected” may be construed to mean “upon determining” or “in response to determining” or “upon detecting [the stated condition or event]” or “in response to detecting [the stated condition or event]” or “responsive to detecting [the stated condition or event]” depending on the context.

As defined herein, the term “responsive to” and similar language as described above, e.g., “if,” “when,” or “upon,” means responding or reacting readily to an action or event. The response or reaction is performed automatically. Thus, if a second action is performed “responsive to” a first action, there is a causal relationship between an occurrence of the first action and an occurrence of the second action. The term “responsive to” indicates the causal relationship.

As defined herein, the term “user” refers to a human being.

As defined herein, the term “hardware processor” means at least one hardware circuit. The hardware circuit may be configured to carry out instructions contained in program code. The hardware circuit may be an integrated circuit. Examples of a hardware processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller.

As defined herein, the terms “one embodiment,” “an embodiment,” “in one or more embodiments,” “in particular embodiments,” or similar language mean that a particular feature, structure, or characteristic described in connection with the embodiment is included in at least one embodiment described within this disclosure. Thus, appearances of the aforementioned phrases and/or similar language throughout this disclosure may, but do not necessarily, all refer to the same embodiment.

As defined herein, the term “substantially” means that the recited characteristic, parameter, or value need not be achieved exactly, but that deviations or variations, including for example, tolerances, measurement error, measurement accuracy limitations, and other factors known to those of skill in the art, may occur in amounts that do not preclude the effect the characteristic was intended to provide.

The terms first, second, etc. may be used herein to describe various elements. These elements should not be limited by these terms, as these terms are only used to distinguish one element from another unless stated otherwise or the context clearly indicates otherwise.

A computer program product may include a computer-readable storage medium (or media) having computer-readable program instructions thereon for causing a processor to carry out aspects of the inventive arrangements described herein. Within this disclosure, the term “program code” is used interchangeably with the term “program instructions.” Computer-readable program instructions described herein may be downloaded to respective computing/processing devices from a computer-readable storage medium or to an external computer or external storage device via a network, for example, the Internet, a LAN, a WAN and/or a wireless network. The network may include copper transmission cables, optical transmission fibers, wireless transmission, routers, firewalls, switches, gateway computers and/or edge devices including edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations for the inventive arrangements described herein may be assembler instructions, instruction-set-architecture (ISA) instructions, machine instructions, machine dependent instructions, microcode, firmware instructions, or either source code or object code written in any combination of one or more programming languages, including an object-oriented programming language and/or procedural programming languages. Computer-readable program instructions may include state-setting data. The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or a WAN, or the connection may be made to an external computer (for example, through the Internet using an Internet Service Provider). In some cases, electronic circuitry including, for example, programmable logic circuitry, an FPGA, or a PLA may execute the computer-readable program instructions by utilizing state information of the computer-readable program instructions to personalize the electronic circuitry, in order to perform aspects of the inventive arrangements described herein.

Certain aspects of the inventive arrangements are described herein with reference to flowchart illustrations and/or block diagrams of methods, apparatus (systems), and computer program products. It will be understood that each block of the flowchart illustrations and/or block diagrams, and combinations of blocks in the flowchart illustrations and/or block diagrams, may be implemented by computer-readable program instructions, e.g., program code.

These computer-readable program instructions may be provided to a processor of a computer, special-purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the operations specified in the flowchart and/or block diagram block or blocks.

The computer-readable program instructions may also be loaded onto a computer, other programmable data processing apparatus, or other device to cause a series of operations to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various aspects of the inventive arrangements. In this regard, each block in the flowchart or block diagrams may represent a module, segment, or portion of instructions, which comprises one or more executable instructions for implementing the specified operations.

In some alternative implementations, the operations noted in the blocks may occur out of the order noted in the figures. For example, two blocks shown in succession may be executed substantially concurrently, or the blocks may sometimes be executed in the reverse order, depending upon the functionality involved. In other examples, blocks may be performed generally in increasing numeric order while in still other examples, one or more blocks may be performed in varying order with the results being stored and utilized in subsequent or other blocks that do not immediately follow. It will also be noted that each block of the block diagrams and/or flowchart illustration, and combinations of blocks in the block diagrams and/or flowchart illustration, may be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-based method, comprising:
simulating a circuit design and a co-simulation model configured to model circuitry that operates in coordination with a hardware implementation of the circuit design, wherein the simulating includes:
in response to a request for a data transfer received by the co-simulation model from the circuit design, providing, from the co-simulation model, a ready signal to the circuit design after a first predetermined number of simulation clock cycles corresponding to an initiation interval of the circuitry modeled by the co-simulation model; and
in response to receiving state information for the data transfer, providing a response from the co-simulation model to the circuit design after a second predetermined number of simulation clock cycles corresponding to a response time of the circuitry modeled by the co-simulation model.

2. The computer-based method of claim 1, wherein the second predetermined number of simulation clock cycles is measured from receipt of the state information by the co-simulation model.

3. The computer-based method of claim 1, wherein the circuitry modeled by the co-simulation model includes a memory controller and a memory coupled to the memory controller.

4. The computer-based method of claim 1, wherein the co-simulation model includes a sequencer and a plurality of drivers forming a communication bus interface of a communication bus between the co-simulation model and the circuit design.

5. The computer-based method of claim 4, wherein one or more of the plurality of drivers are configured to count the first predetermined number of simulation clock cycles.

6. The computer-based method of claim 4, wherein the sequencer is configured to count the second predetermined number of simulation clock cycles.

7. The computer-based method of claim 1, wherein the data transfer is a read operation, the request includes assertion of a valid signal of a read address-control channel, and the response includes data read from an array of the co-simulation model.

8. The computer-based method of claim 1, wherein the data transfer is a write operation and the request includes assertion of a valid signal of a write address-control channel and assertion of a valid signal of a write data channel.

9. The computer-based method of claim 8, wherein the response is a valid signal asserted on a write response channel.

10. A system, comprising:
one or more hardware processors configured to initiate operations including:
simulating a circuit design and a co-simulation model configured to model circuitry that operates in coordination with a hardware implementation of the circuit design, wherein the simulating includes:
in response to a request for a data transfer received by the co-simulation model from the circuit design, providing, from the co-simulation model, a ready signal to the circuit design after a first predetermined number of simulation clock cycles corresponding to an initiation interval of the circuitry modeled by the co-simulation model; and
in response to receiving state information for the data transfer,
providing a response from the co-simulation model to the circuit design after a second predetermined number of simulation clock cycles corresponding to a response time of the circuitry modeled by the co-simulation model.

11. The system of claim 10, wherein the second predetermined number of simulation clock cycles is measured from receipt of the state information by the co-simulation model.

12. The system of claim 10, wherein the circuitry modeled by the co-simulation model includes a memory controller and a memory coupled to the memory controller.

13. The system of claim 10, wherein the co-simulation model includes a sequencer and a plurality of drivers forming a communication bus interface of a communication bus between the co-simulation model and the circuit design.

14. The system of claim 13, wherein one or more of the plurality of drivers are configured to count the first predetermined number of simulation clock cycles.

15. The system of claim 13, wherein the sequencer is configured to count the second predetermined number of simulation clock cycles.

16. The system of claim 10, wherein the data transfer is a read operation, the request includes assertion of a valid signal of a read address-control channel, and the response includes data read from an array of the co-simulation model.

17. The system of claim 10, wherein the data transfer is a write operation and the request includes assertion of a valid signal of a write address-control channel and assertion of a valid signal of a write data channel.

18. The system of claim 17, wherein the response is a valid signal asserted on a write response channel.

19. A computer program product comprising one or more computer readable storage mediums having program instructions embodied therewith, wherein the program instructions are executable by computer hardware to cause the computer hardware to initiate executable operations comprising:
simulating a circuit design and a co-simulation model configured to model circuitry that operates in coordination with a hardware implementation of the circuit design, wherein the simulating includes:
in response to a request for a data transfer received by the co-simulation model from the circuit design, providing, from the co-simulation model, a ready signal to the circuit design after a first predetermined number of simulation clock cycles corresponding to an initiation interval of the circuitry modeled by the co-simulation model; and
in response to receiving state information for the data transfer, providing a response from the co-simulation model to the circuit design after a second predetermined number of simulation clock cycles corresponding to a response time of the circuitry modeled by the co-simulation model.

20. The computer program product of claim 19, wherein the co-simulation model includes a sequencer and a plurality of drivers forming a communication bus interface of a communication bus between the co-simulation model and the circuit design.
